(19) United States
(12) Patent Application Publication
(10) Pub. No.: US 2004/0252140 A1
(43) Pub. Date: Dec. 16, 2004

(54) Apparatus for displaying images at multiple gray scales and method of reducing moving-picture pseudo-frame in the apparatus

(75) Inventors: Shinichi Inoue, Tokyo (JP); Masahiko Okuzawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/864,402

(22) Filed: Jun. 10, 2004

(30) Foreign Application Priority Data
Jun. 12, 2003 (JP) 2003-167953

(51) Int. Cl. G09G 5/10

(52) U.S. Cl. 345/690

(57) ABSTRACT

An apparatus for displaying images at multiple gray scales, when each of pixels in image is displayed based on image signals having a certain number of bits, defines a field with a plurality of sub-fields each having a weighted brightness, to establish a desired gray scale. The apparatus includes a signal-arrangement changer which changes arrangement of a part of bit signals among bit signals constituting an image signal, in a plurality of pixels. The apparatus displays images, based on image signals, after the arrangement has been changed by the signal-arrangement changer.

### BACKGROUND OF THE INVENTION

1. Field of the Invention

The invention relates to an apparatus for displaying images at multiple gray scales, and a method of reducing moving-picture pseudo-frame in the apparatus.

2. Description of the Related Art

For instance, Japanese Patent Application Publication No. 7-271325 (A) has suggested a method of displaying images at multiple gray scales. In the suggested method, a field having 64 gray scales is comprised of six sub-fields having a brightness ratio of 1:2:4:8:16:32. These six sub-fields are displayed in a fixed order.

However, the suggested method is accompanied with a problem that, when moving-pictures are displayed in accordance with the method, if gray scales are varied to cause much variation in a combination of sub-fields to be turned on, there is caused significant non-uniformity in a period of time for light-emission with the result of much turbulence in gray scales. For instance, a combination of sub-fields to be turned on is much varied, if gray scales are varied between 63 and 64, 31 and 32 or 15 and 16.

In order to prevent such turbulence in gray scales, the sub-fields are turned on in another order, or a number of sub-fields constituting a field is increased such that there are two or more combinations of sub-fields to be turned on for displaying images at a certain gray scale. Such turbulence in gray scales may be spatially diffused by signal processing such as error-diffusion.

As a method of reducing moving-picture pseudo-frame, a so-called equalizing-pulse process has been suggested.

In accordance with the suggested equalizing-pulse process, when it is estimated that turbulence in gray scales would be observed when a line of sight moves on a display on which images are displayed in accordance with a sub-field process, lights are added to signals transmitted from a light source or lights are reduced from signals transmitted from a light source to ensure reduction in turbulence in gray scales.

Japanese Patent Application Publication No. 2003-157045 has suggested a method of suppressing generation of moving-picture pseudo-frame.

The suggested method includes the step of changing arrangement of pixels in which moving-picture pseudo-frames are likely to be caused. In accordance with the suggested method, pixels are re-arranged such that turbulence in brightness and turbulence in darkness are alternately generated, and hence, the turbulences are canceled each other, resulting in reduction in moving-picture pseudo-frames.

In order to display images at 2N gray scales wherein N is a positive integer, it is necessary to prepare N sub-fields. If (N+1) or more sub-fields are prepared for reducing non-uniformity in a period of time for light-emission to thereby reduce moving-picture pseudo-frame in a conventional apparatus for displaying images at multiple gray scales, a period of time in which sustaining-discharges are generated is shortened with the result of reduction in brightness, for instance, in a plasma display apparatus. That is, the conventional apparatus is accompanied with a problem that it is not possible to increase a number of sub-fields for reducing moving-picture pseudo-frame, without reduction in brightness.

The conventional apparatus is accompanied further with a problem that it is not possible to prevent turbulence in gray scales at a particular gray scale, because such turbulence occurs at the particular gray scale even when a number of sub-fields is increased.

The conventional signal-processing method such as error-diffusion is accompanied with a problem that input signals associated with areas other than an area in which moving-picture pseudo-frame is generated are degraded, because input signals are all processed in the conventional signal-processing method regardless of whether moving-picture pseudo-frame is generated.

The conventional signal-processing method such as error-diffusion is accompanied further with a problem that it is not possible to estimate influence caused by diffused turbulence in gray scales, because such turbulence is diffused without regularity.

In the above-mentioned equalizing-pulse process, in order to reduce turbulence in images which a viewer can recognize with his/her eyes, movement of images is detected in input signals, and the input signals are compensated for in accordance with a moving rate of the images. However, a motion vector can be detected with poor accuracy for some images, and hence, the equalizing-pulse is accompanied with a problem that wrong signal-compensation might degrade quality in moving pictures.

Furthermore, it is on the assumption in the equalizing-pulse process that a line of sight of a viewer follows moving image. Hence, the method is accompanied with a problem that if a line of sight of a viewer does not follow moving picture, the viewer might recognize turbulence in image, caused by signals compensated for.

The above-mentioned method suggested in Japanese Patent Application Publication No. 2003-157045 is accompanied with a problem of degradation in image quality. The Publication further suggests an example in which pixels in a row in a certain direction are re-arranged. However, the example ensures that moving-picture pseudo-frame can be suppressed only in movement of images in a particular direction, but does not ensure that moving-picture pseudo-frame is suppressed in movement of images in other directions.

### SUMMARY OF THE INVENTION

In view of the above-mentioned problems in the prior art, it is an object of the present invention to provide an apparatus for displaying images at multiple gray scales which is capable of reducing moving-picture pseudo-frame in movement of images in a plurality of directions without degradation in image quality.

It is also an object of the present invention to provide a method of reducing moving-picture pseudo-frame which is capable of doing the same.

Hereinbelow are described an apparatus for displaying images at multiple gray scales and a method of reducing moving-picture pseudo-frame both in accordance with the present invention through the use of reference numerals used in later described embodiments. The reference numerals are indicated only for the purpose of clearly showing correspondence between claims and the embodiments. It should be noted that the reference numerals are not allowed to interpret of claims of the present application.

In one aspect of the present invention, there is provided an apparatus for displaying images at multiple gray scales. The apparatus, when each of pixels in image is displayed based on image signals having a certain number of bits, defines a field with a plurality of sub-fields each having a weighted brightness, to establish a desired gray scale. The apparatus includes a signal-arrangement changer (13) which changes arrangement of a part of bit signals among bit signals constituting an image signal, in a plurality of pixels, and displays images, based on image signals, after the arrangement has been changed by the signal-arrangement changer (13).

In accordance with the present invention, image signals are re-arranged among a plurality of pixels, and images are displayed based on the thus re-arranged images signals, ensuring reduction in moving-picture pseudo-frame. In addition, since only a part of bit signals among bit signals constituting an image signal is re-arranged among a plurality of pixels, it would be possible to suppress degradation in image quality relative to images derived from original image signals, in comparison with re-arrangement of all bits in an image signal among a plurality of pixels. Thus, the present invention makes it possible to reduce moving-picture pseudo-frame without degradation in image quality.

It is preferable that the signal-arrangement changer (13) carries out the arrangement-changing to a plurality of bit signals among bit signals constituting an image signal.

It is preferable that the apparatus includes a plurality of signal-arrangement changers (13) each for each of bit signals to which the arrangement-changing is carried out.

It is preferable that the signal-arrangement changer (13) carries out the arrangement-changing to a smaller range of pixels in upper bits.

It is preferable that the signal-arrangement changer (13) carries out the arrangement-changing only to lower N-bit signals among bit signals constituting an image signal, wherein N is a positive integer.

The apparatus may further include a device (11) which estimates whether moving-picture pseudo-frame is generated when images are displayed without carrying out the signal-arrangement changing to image signals, wherein the signal-arrangement changer (13), when the device (11) estimates that moving-picture pseudo-frame is generated, carries out the signal-arrangement changing to images signals associated with pixels including pixels in which the moving-picture pseudo-frame is estimated to be generated.

For instance, the apparatus may be comprised of a plasma display apparatus.

There is further provided an apparatus for displaying images at multiple gray scales. The apparatus, when each of pixels in image is displayed based on image signals having a certain number of bits, defines a field with a plurality of sub-fields each having a weighted brightness, to establish a desired gray scale. The apparatus includes a signal-arrangement changer (13) which changes arrangement of image signals within a plurality of pixels such that a part of pixels among pixels constituting image is shifted without changing arrangement of pixels in the part, and displays images, based on image signals, after the arrangement has been changed by the signal-arrangement changer (13).

In accordance with the present invention, image signals are re-arranged within a plurality of pixels such that a part of pixels among pixels constituting image is shifted without changing arrangement of pixels in the part of pixels. Thus, it is possible to reduce moving-picture pseudo-frame. In addition, moving-picture pseudo-frame is reduced independently of a direction in which moving-picture moves.

It is preferable that the signal-arrangement changer (13) carries out 90-degrees rotation, mirror-image reversal, repetition of them alone or in combination to M×M pixels as the part of pixels, wherein M indicates a positive integer equal to or greater than two.

It is preferable that the signal-arrangement changer (13) carries out mirror-image reversal to M×N pixels as the part of pixels, wherein each of M and N indicates a positive integer equal to or greater than two and M is not equal to N.

It is preferable that the signal-arrangement changer (13) carries out the arrangement-changing only to a part of bit signals among bit signals constituting an image signal.

In another aspect of the present invention, there is provided a method of reducing moving-picture pseudo-frame in an apparatus for displaying images at multiple gray scales, the apparatus, when each of pixels in image is displayed based on image signals having a certain number of bits, defining a field with a plurality of sub-fields each having a weighted brightness, to establish a desired gray scale, the method including changing arrangement of a part of bit signals among bit signals constituting an image signal, in a plurality of pixels, and displaying images, based on image signals, after the arrangement has been changed by the signal-arrangement changer (13).

It is preferable that the arrangement-changing is carried out to a plurality of bit signals among bit signals constituting an image signal.

It is preferable that the arrangement-changing is carried out to a smaller range of pixels in upper bits.

It is preferable that the arrangement-changing is carried out only to lower N-bit signals among bit signals constituting an image signal, wherein N is a positive integer.

The method may further include the step of estimating whether moving-picture pseudo-frame is generated when images are displayed without carrying out the signal-arrangement changing to image signals, wherein when moving-picture pseudo-frame is estimated to be generated, the signal-arrangement changing is carried out to images signals associated with pixels including pixels in which the moving-picture pseudo-frame is estimated to be generated.

There is further provided a method of reducing moving-picture pseudo-frame in an apparatus for displaying images at multiple gray scales, the apparatus, when each of pixels in image is displayed based on image signals having a certain number of bits, defining a field with a plurality of sub-fields each having a weighted brightness, to establish a desired gray scale, the method including changing arrangement of image signals within a plurality of pixels such that a part of pixels among pixels constituting image is shifted without changing arrangement of pixels in the part, and displaying images, based on image signals, after the arrangement has been changed by the signal-arrangement changer (13).

It is preferable that 90-degrees rotation, mirror-image reversal, repetition of them alone or in combination is carried out as signal-arrangement changing to M×M pixels as the part of pixels, wherein M indicates a positive integer equal to or greater than two.

It is preferable that mirror-image reversal is carried out as signal-arrangement changing to M×N pixels as the part of pixels, wherein each of M and N indicates a positive integer equal to or greater than two and M is not equal to N.

It is preferable that the arrangement-changing is carried out only to a part of bit signals among bit signals constituting an image signal.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a circuit for processing an image signal, included in a plasma display apparatus as the first embodiment of the apparatus for displaying images at multiple gray scales, in accordance with the present invention.

FIG. 2 illustrates 2×2 image data sampled in the circuit illustrated in FIG. 1.

FIG. 3 illustrates 2×2 image data comprised of upper 5-bit image signal to which re-arrangement is not carried out, and lower 3-bit image signal to which re-arrangement is carried out.

FIG. 4 is a flow-chart showing an operation of the circuit illustrated in FIG. 1.

FIG. 5 illustrates an example of input images.

FIG. 6 shows re-arrangement to be carried out to the input images illustrated in FIG. 5.

FIG. 7 illustrates another example of input images.

FIG. 8 shows re-arrangement to be carried out to the input images illustrated in FIG. 6.

FIG. 9 is a block diagram of a circuit for processing an image signal, included in a plasma display apparatus as the second embodiment of the apparatus in accordance with the present invention.

FIG. 10 is a block diagram of a circuit for processing an image signal, included in a plasma display apparatus as the third embodiment of the apparatus in accordance with the present invention.

FIG. 11 is a block diagram of a circuit for processing an image signal, included in a plasma display apparatus as the fourth embodiment of the apparatus in accordance with the present invention.

FIG. 12 is a block diagram of a circuit for processing an image signal, included in a plasma display apparatus as the fifth embodiment of the apparatus in accordance with the present invention.

FIG. 13 is a block diagram of a circuit for processing an image signal, included in a plasma display apparatus as the sixth embodiment of the apparatus in accordance with the present invention.

FIG. 14 is a block diagram of a circuit for processing an image signal, included in a plasma display apparatus as the seventh embodiment of the apparatus in accordance with the present invention.

FIG. 15 is a block diagram of a circuit for processing an image signal, included in a plasma display apparatus as the eighth embodiment of the apparatus in accordance with the present invention.

FIG. 16 is a block diagram of a circuit for processing an image signal, included in a plasma display apparatus as the ninth embodiment of the apparatus in accordance with the present invention.

FIG. 17 is a block diagram of a circuit for processing an image signal, included in a plasma display apparatus as the tenth embodiment of the apparatus in accordance with the present invention.

FIG. 18 is a block diagram of a circuit for processing an image signal, included in a plasma display apparatus as the eleventh embodiment of the apparatus in accordance with the present invention.

FIG. 19 is a block diagram of a circuit for processing an image signal, included in a plasma display apparatus as the twelfth embodiment of the apparatus in accordance with the present invention.

### DESCRIPTION OF THE PREFERRED EMBODIMENTS

Preferred embodiments in accordance with the present invention will be explained hereinbelow with reference to drawings.

[First Embodiment]

The apparatus for displaying images at multiple gray scales, in accordance with the first embodiment of the present invention is comprised of a plasma display apparatus.

The plasma display apparatus is comprised of a plasma display panel (not illustrated) and a circuit 10 for processing image signals.

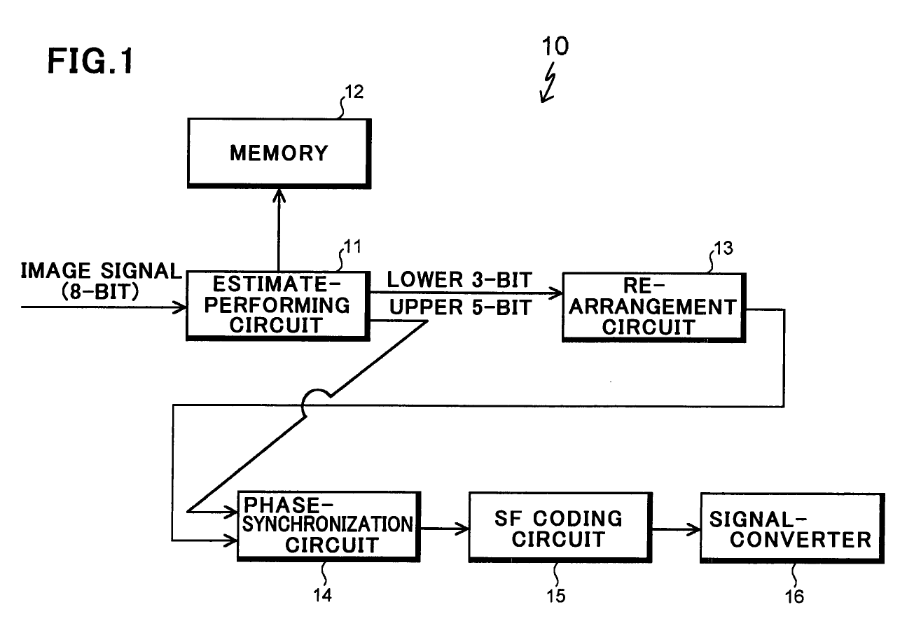

FIG. 1 is a block diagram of the circuit 10. As illustrated in FIG. 1, the circuit 10 is comprised of an estimate-performing circuit 11 for estimating whether moving-picture pseudo-frame is generated, a memory 12, a re-arrangement circuit 13, a phase-synchronization circuit 14, a sub-field (SF) coding circuit 15, and a signal-converter 16.

The estimate-performing circuit 11 receives an image signal having a certain bit (for instance, a 8-bit image signal), and compares a brightness of displayed pixels, indicated in the received image signal, to a brightness at which moving-picture pseudo-frame is generated, to thereby estimate whether moving-picture pseudo-frame is generated.

The memory 12 stores a brightness at which moving-picture pseudo-frame is generated. The estimate-performing circuit 11 reads the brightness out of the memory 12, and then, carries out the above-mentioned comparison.

The re-arrangement circuit 13 carries out re-arrangement to image signals, if the estimate-performing circuit 11 estimates generation of moving-picture pseudo-frame.

The phase-synchronization circuit 14 synchronizes a delay in a bit signal (for instance, lower 3-bit signal) to which re-arrangement was carried out by the re-arrangement circuit 13 and a delay in a bit signal (for instance, upper 5-bit signal) to which re-arrangement was not carried out, with each other.

The SF coding circuit 15 converts the image signals output from the phase-synchronization circuit 14, into image signals comprised of a plurality of sub-fields.

The signal-converter 16 converts the image signals output from the SF coding circuit 15, into drive signals in accordance with which the plasma display panel is driven.

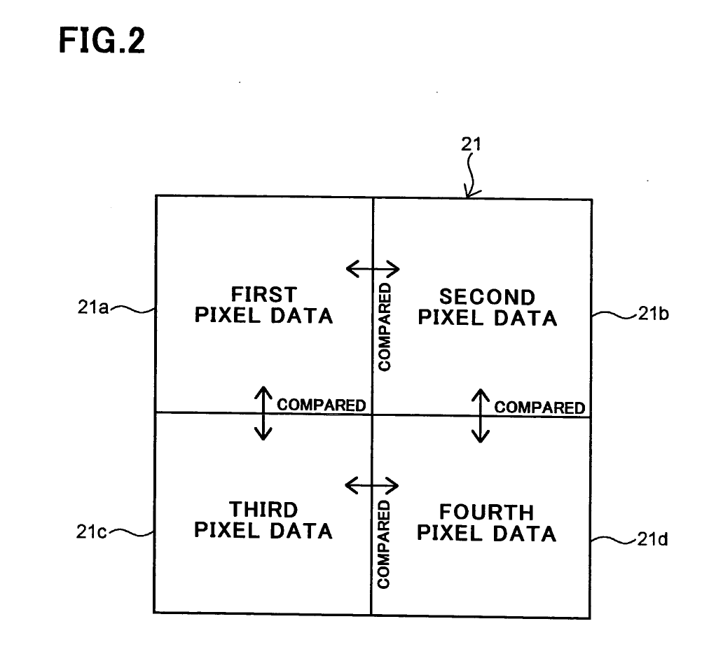

The circuit 11 is designed to sample every image signals input into the circuit 10 for displaying certain pixels, that is, a part of pixels among pixels constituting image. In the first embodiment, the circuit 11 is designed to sample every 2×2 pixels, that is, pixels arranged in two rows and two columns. Hereinbelow, for simplification, an image signal for displaying 2×2 pixels is referred to as 2×2 data 21, an example of which is illustrated in FIG. 2. Hereinbelow, pixels arranged in two rows and two columns, to be displayed based on 2×2 data 21, are referred to simply as 2×2 pixels.

The estimate-performing circuit 11 is designed to estimate whether moving-picture pseudo-frame is generated, if images are displayed without carrying out the later-mentioned re-arrangement to the thus sampled 2×2 data 21.

The estimate-performing circuit 11 estimates whether moving-picture pseudo-frame is generated, by comparing a brightness of each of pixels displayed based on each of pixel data included the 2×2 data 21, that is, first pixel data 21a, second pixel data 21b, third pixel data 21c and fourth pixel data 21d, to a brightness at which moving-picture pseudo-frame is generated, stored in the memory 12.

The comparison is carried out by the estimate-performing circuit 11 in accordance with the following inequalities. Only a part of the inequalities is described hereinbelow, because there are a lot of the inequalities, but they have simple regularity. Hereinbelow, a brightness at which moving-picture pseudo-frame is generated is referred to simply as a PF brightness.

Brightness of a first pixel<First PF brightness<Brightness of a second pixel

Brightness of a first pixel<First PF brightness<Brightness of a third pixel

Brightness of a third pixel<First PF brightness<Brightness of a fourth pixel

Brightness of a second pixel<First PF brightness<Brightness of a fourth pixel

Brightness of a second pixel<First PF brightness<Brightness of a first pixel

Brightness of a third pixel<First PF brightness<Brightness of a first pixel

Brightness of a fourth pixel<First PF brightness<Brightness of a third pixel

Brightness of a fourth pixel<First PF brightness<Brightness of a second pixel

Brightness of a first pixel<Second PF brightness<Brightness of a second pixel

Brightness of a first pixel<Second PF brightness<Brightness of a third pixel

Brightness of a third pixel<Second PF brightness<Brightness of a fourth pixel

Brightness of a second pixel<Second PF brightness<Brightness of a fourth pixel

Brightness of a second pixel<Second PF brightness<Brightness of a first pixel

Brightness of a third pixel<Second PF brightness<Brightness of a first pixel

Brightness of a fourth pixel<Second PF brightness<Brightness of a third pixel

Brightness of a fourth pixel<Second PF brightness<Brightness of a second pixel

### (Partially omitted)

Brightness of a first pixel<Fifteenth PF brightness<Brightness of a second pixel

Brightness of a first pixel<Fifteenth PF brightness<Brightness of a third pixel

Brightness of a third pixel<Fifteenth PF brightness<Brightness of a fourth pixel

Brightness of a second pixel<Fifteenth PF brightness<Brightness of a fourth pixel

Brightness of a second pixel<Fifteenth PF brightness<Brightness of a first pixel

Brightness of a third pixel<Fifteenth PF brightness<Brightness of a first pixel

Brightness of a fourth pixel<Fifteenth PF brightness<Brightness of a third pixel

Brightness of a fourth pixel<Fifteenth PF brightness<Brightness of a second pixel

Brightness of a first pixel<Sixteenth PF brightness<Brightness of a second pixel

Brightness of a first pixel<Sixteenth PF brightness<Brightness of a third pixel

Brightness of a third pixel<Sixteenth PF brightness<Brightness of a fourth pixel

Brightness of a second pixel<Sixteenth PF brightness<Brightness of a fourth pixel

Brightness of a second pixel<Sixteenth PF brightness<Brightness of a first pixel

Brightness of a third pixel<Sixteenth PF brightness<Brightness of a first pixel

Brightness of a fourth pixel<Sixteenth PF brightness<Brightness of a third pixel

Brightness of a fourth pixel<Sixteenth PF brightness<Brightness of a second pixel

In the inequalities listed above, each of pixels in 2×2 pixels is assumed to have a brightness of a first pixel corresponding to the first pixel data 21a, a brightness of a second pixel corresponding to the second pixel data 21b, a brightness of a third pixel corresponding to the third pixel data 21c, and a brightness of a fourth pixel corresponding to the fourth pixel data 21d.

A PF brightness is defined as a brightness across which a combination of sub-fields to be turned on is significantly re-arranged. Accordingly, a PF brightness and a number thereof are dependent only on a brightness weight assigned to each of sub-fields and sub-field coding. At least one PF brightness (sixteen PF brightnesses in the above-mentioned list) is stored in the memory 12.

The estimate-performing circuit 11 makes judgment through the use of all of the inequalities listed above to thereby judge whether a first condition is established. Herein, the first condition is “there exists any one of the first to N-th PF brightness across brightnesses of pixels adjacent to each other among 2×2 pixels”.

If the estimate-performing circuit 11 judges that the first condition is established, that is, at least one of the above-listed inequalities is established, the re-arrangement circuit 13 carries out the re-arrangement to lower 3-bit of the 8-bit input image signal.

In the re-arrangement carried out by the re-arrangement circuit 13 in the first embodiment, image signals are re-arranged in a common field among pixels contained a certain group of pixels. For instance, 2×2 pixels are rotated without changing the arrangement thereof in a counterclockwise (or clockwise) direction by 90 degrees.

The re-arrangement in the first embodiment is carried out only to a part of bits (for instance, lower three bits) constituting an image signal.

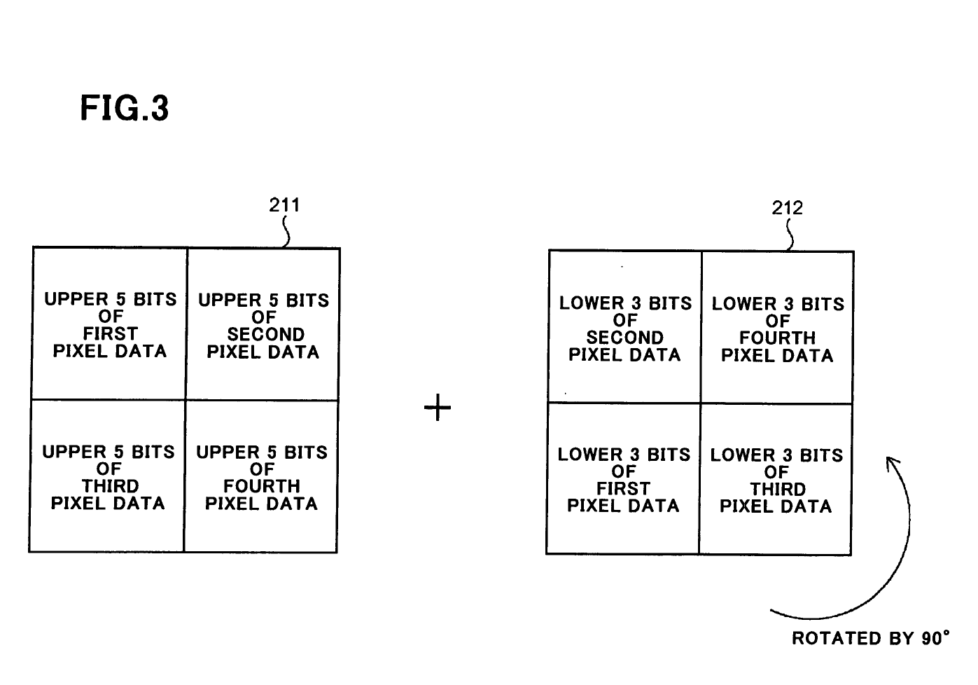

For instance, as illustrated in FIG. 3, the re-arrangement is not carried out to an upper 5-bit image signal 211 as a part of the 2×2 data 21, whereas the re-arrangement is carried out to a lower 3-bit image signal 212 as a part of the 2×2 data 21.

As a result, for instance, the first pixel data obtained as a result of the re-arrangement is comprised of upper five bits of the original first pixel data 21a, and lower three bits of the original second pixel data 21b. Similarly, the second pixel data obtained as a result of the re-arrangement is comprised of upper five bits of the original second pixel data 21b, and lower three bits of the original fourth pixel data 21d. The third pixel data obtained as a result of the re-arrangement is comprised of upper five bits of the original third pixel data 21c, and lower three bits of the original first pixel data 21a. The fourth pixel data obtained as a result of the re-arrangement is comprised of upper five bits of the original fourth pixel data 21d, and lower three bits of the original third pixel data 21c.

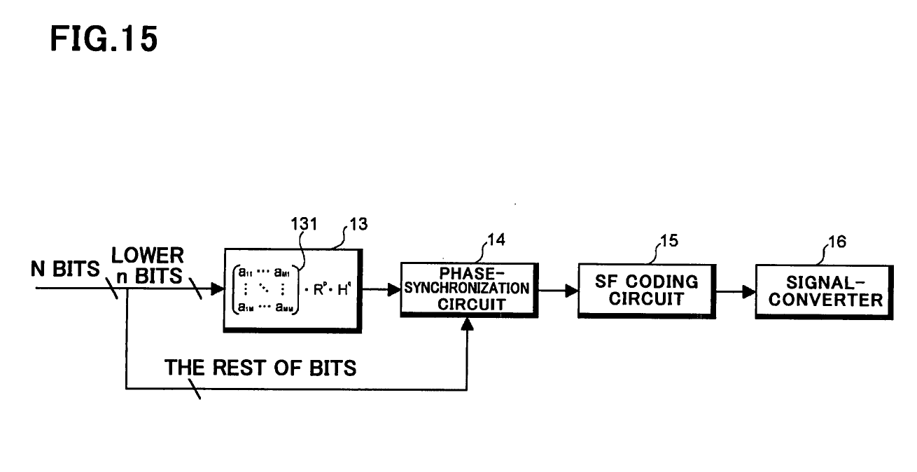

Hereinbelow is explained the re-arrangement with reference to FIG. 15.

With reference to FIG. 15, a part of a bit-signal (for instance, lower three bits) is input into the re-arrangement circuit 13, and the rest of the bit-signal (for instance, upper five bits) is input not into the re-arrangement circuit 13, but into the phase-synchronization circuit 14. The re-arrangement is carried out only to the part of the bit-signal in the re-arrangement circuit 13.

A matrix 131 stored in the re-arrangement circuit 13 has M rows and M columns. That is, the matrix 131 is a M×M matrix. A symbol “R” indicates a rotation matrix which rotates the M×M matrix in a counterclockwise direction by 90 degrees. Accordingly, if an exponent “p” of the rotation matrix R is equal to one (1), the matrix 131 is rotated in a counterclockwise direction by 90 degrees.

In FIG. 15, a symbol “H” indicates a reversal matrix which carries out mirror-image reversal to the matrix 131, as mentioned later. In the first embodiment, mirror-image reversal is not carried out to the matrix 131, and hence, an exponent “p” of the reversal matrix H is set equal to zero (0).

The phase-synchronization circuit 14 adjusts a delay in the lower 3-bit signal 212 (see FIG. 3) to which the re-arrangement was carried out by the re-arrangement circuit 13 and a delay in the upper 5-bit signal 211 to which the re-arrangement was not carried out, to each other.

The image signals output from the phase-synchronization circuit 14 are converted in the SF coding circuit 15 into image signals comprised of a plurality of sub-fields. Then, the signal-converter 16 converts the image signals output from the SF coding circuit 15, into drive signals in accordance with which the plasma display panel is driven. Then, the image signals are output to the plasma display panel from the SF coding circuit 15.

The plasma display panel displays images in accordance with the drive signals received from the SF coding circuit 15. That is, the plasma display panel displays images in accordance with the image signals which was input into the circuit 10 and to which the re-arrangement was carried out by the re-arrangement circuit 13.

The plasma display apparatus in accordance with the first embodiment has such a structure as mentioned above.

Hereinbelow is explained an operation of the plasma display apparatus.

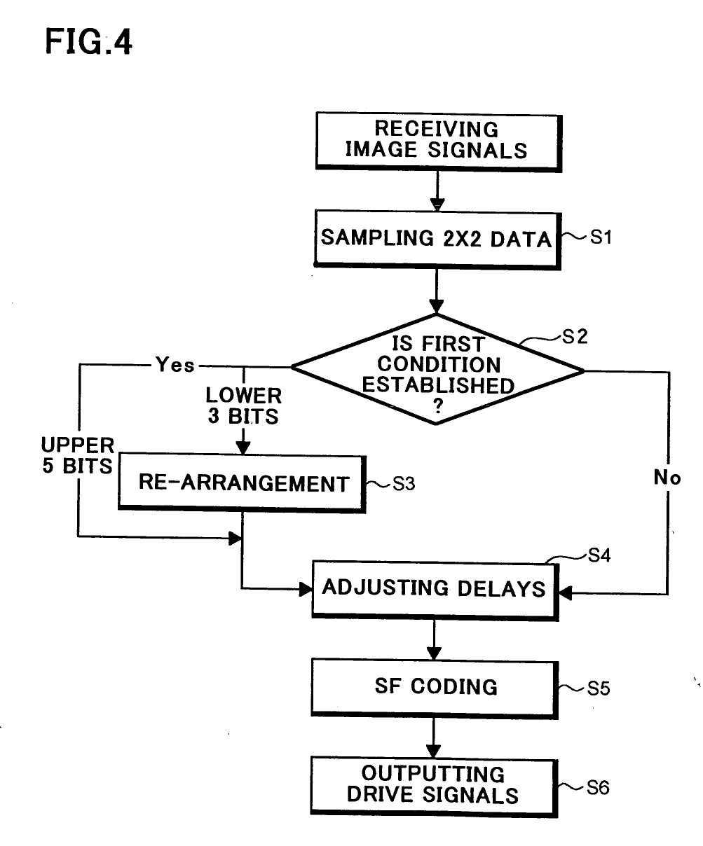

First, the signal-processing carried out by the circuit 10 is explained hereinbelow with reference to FIG. 4.

First, the estimate-performing circuit 11 samples 2×2 data 21 included in the received image signal, in step S1.

Then, the estimate-performing circuit 11 judges whether the above-mentioned first condition is established, in step S2. Specifically, the estimate-performing circuit 11 judges whether gray scales vary across any one of first to N-th PF brightnesses between pixels adjacent to each other among pixels included in 2×2 pixels corresponding to the 2×2 data 21, if images are displayed without carrying out the re-arrangement to the sampled 2×2 data 21.

If the estimate-performing circuit 11 judges that the first condition is established (YES in step S2), the re-arrangement circuit 13 carries out the re-arrangement to lower three bits of the first to fourth pixel data 21a to 21d. Specifically, the re-arrangement circuit 13 applies rotation by 90 degrees in a counterclockwise (or clockwise) direction to lower three bits of the first to fourth pixel data 21a to 21d, in step S3. Even if the estimate-performing circuit 11 judges that the first condition is established (YES in step S2), the re-arrangement is not carried out to upper five bits of the first to fourth pixel data 21a to 21d.

If the estimate-performing circuit 11 judges that the first condition is not established (NO in step S2), the re-arrangement circuit 13 does not carry out the re-arrangement to all bits of the first to fourth pixel data 21a to 21d.

The image signal is input into the phase-synchronization circuit 14 regardless of whether the re-arrangement was carried out to any bit of the image signal. The phase-synchronization circuit 14 uniformizes a delay in the received image signal. Specifically, when the first condition was established, a delay in the lower 3-bit signal to which the re-arrangement was carried out by the re-arrangement circuit 13 and a delay in the upper 5-bit signal to which the re-arrangement was not carried out are adjusted to each other.

Then, the image signal is converted to associated sub-fields in the SF coding circuit 15, in step S5, and then, output as drive signals to the plasma display panel, in step S6. Thus, the plasma display panel displays images in accordance with the received drive signals.

Hereinbelow is explained in detail the above-mentioned re-arrangement carried out by the re-arrangement circuit 13.

It is assumed that a field is comprised of eleven sub-fields to which a brightness weight 1, 2, 4, 7, 11, 17, 24, 32, 41, 52 and 64 is assigned, respectively, in a turning-on order, and images are displayed at 8-bit gray scales.

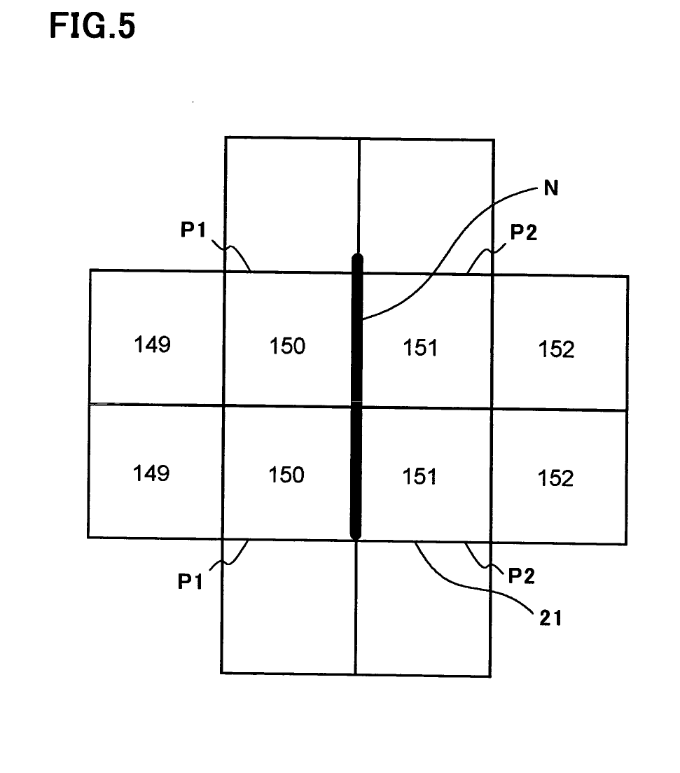

FIG. 5 illustrates images to which the re-arrangement is not applied.

As illustrated in FIG. 5, a brightness horizontally varies, in each of upper and lower rows, in a sequence of 149, 150, 151 ad 152 for every input pixel.

If SF coding is carried out to the input image signals with the above-mentioned brightness weights without carrying out the re-arrangement to the image signals, a combination of sub-fields to turn on (that is, a profile of pulse light-emission in a field) much varies across pixels P1 each having a brightness of 150 and pixels P2 each having a brightness of 151. Specifically, assuming that light-emission is expressed as “1” and non light-emission is expressed as “0”, if a brightness is expressed with the sub-fields having the above-mentioned brightness weights, a brightness of 150 is expressed as [1 1 1 1 1 1 1 1 0 1 0], whereas a brightness of 151 is expressed as [0 1 1 0 1 1 1 0 1 1 0]. Thus, a light-emission profile of the sub-fields to be turned on prior to the sub-field having a brightness weight of 41, namely, a light-emission profile of the sub-fields having brightness weights [1, 2, 4, 7, 11, 17, 24, 32, 41] much varies. As a result, there appears such moving-picture pseudo-frame N as illustrated in FIG. 5.

It is assumed for simplification that the moving-picture pseudo-frame N is generated only when a brightness varies across 150 and 151, in other words, a PH brightness exists only between brightnesses 150 and 151.

In the plasma display apparatus in accordance with the first embodiment, as a result that the estimate-performing circuit 11 estimates generation of the moving-picture pseudo-frame N, the re-arrangement circuit 13 carries out the re-arrangement such as rotation. Hence, it is possible to reduce generation of moving-picture pseudo-frame, that is, it is ensured that a viewer scarcely recognizes moving-picture pseudo-frame.

Assuming that the re-arrangement is carried out to the centrally located 2×2 data 21 in FIG. 5, a brightness of the first pixel is 150, a brightness of the second pixel is 151, a brightness of the third pixel is 150, and a brightness of the fourth pixel is 151.

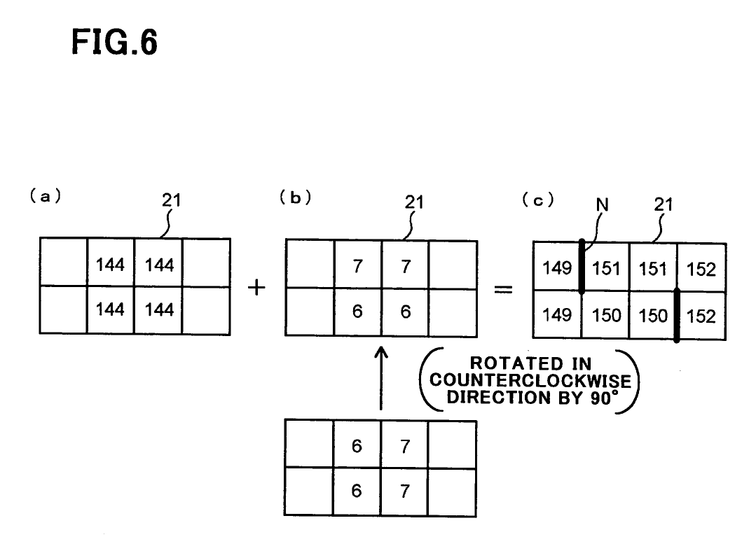

By carrying out the re-arrangement, whereas the upper five bits are kept unchanged, as illustrated in the section (a) in FIG. 6, the lower three bits are rotated in a counterclockwise direction by 90 degrees, as illustrated in the section (b) in FIG. 6. By adding the upper five bits and the lower three bits to each other, there is obtained a brightness profile as illustrated in the section (c) in FIG. 6.

As illustrated in the section (c) in FIG. 6, there are obtained a brightness profile of 149, 151, 151 and 152 in an upper row, and a brightness profile of 149, 150, 150 and 152 in a lower row. As a result, sites at which the moving-picture pseudo-frame N is generated are spatially diffused. Specifically, pixels across which a brightness varies between 149 and 151 and pixels across which a brightness varies between 150 and 152 are separated away from each other. Thus, unlike the 2×2 data 21 illustrated in FIG. 5, a viewer hardly recognizes the moving-picture pseudo-frame N as a clear line. That is, the moving-picture pseudo-frame N is hardly recognized by a viewer.

In FIG. 6, the brightness 144 shown in the section (a) corresponds to five bits out of eight bits constituting the brightness 150 and 151 in equivalence. Similarly, the brightness 6 and 7 shown in the section (b) correspond to three bits out of eight bits constituting the brightness 150 and 151 in equivalence.

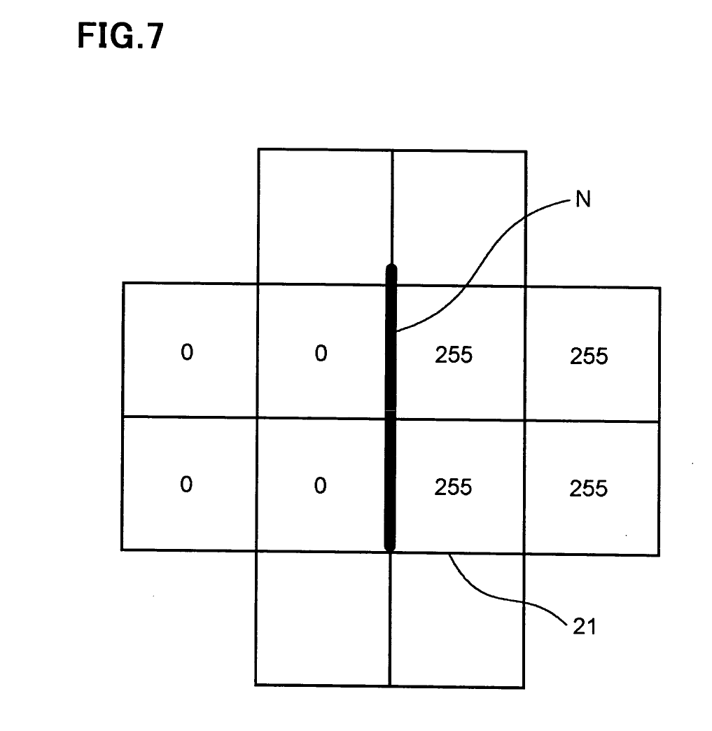

FIG. 7 illustrates an example of image to which the re-arrangement is not carried out.

FIG. 7 illustrates pixels arranged in upper and lower rows each having a brightness profile of 0, 0, 255 and 255. Since a light-emission profile in sub-fields much varies across brightnesses 0 and 255, there is generated moving-picture pseudo-frame N.

In FIG. 7, the moving-picture pseudo-frame N is generated when a brightness much varies from 0 to 255. Hence, the moving-picture pseudo-frame N is hardly recognized by a monitor, causing no problems. However, even so, the re-arrangement circuit 13 carries out the re-arrangement as a result that the estimate-performing circuit 11 estimates generation of the moving-picture pseudo-frame N.

Assuming that the re-arrangement is carried out to the centrally located 2×2 data 21 in FIG. 7, a brightness of the first pixel is 0, a brightness of the second pixel is 255, a brightness of the third pixel is 0, and a brightness of the fourth pixel is 255.

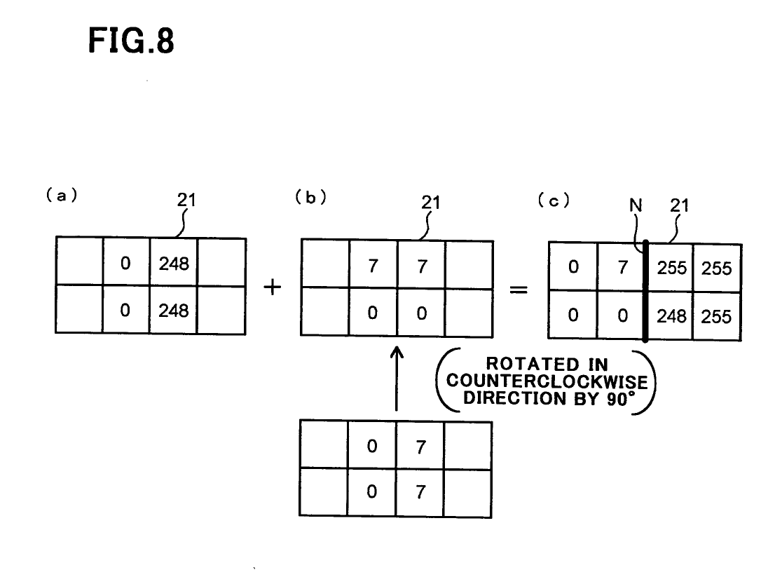

By carrying out the re-arrangement, whereas the upper five bits are kept unchanged, as illustrated in the section (a) in FIG. 8, the lower three bits are rotated in a counterclockwise direction by 90 degrees, as illustrated in the section (b) in FIG. 8. By adding the upper five bits and the lower three bits to each other, there is obtained a brightness profile as illustrated in the section (c) in FIG. 8.

As illustrated in the section (c) in FIG. 8, there are obtained a brightness profile of 0, 7, 255 and 255 in an upper row, and a brightness profile of 0, 0, 248 and 255 in a lower row.

If the re-arrangement is carried out to all of eight bits, a brightness of the first pixel (0) is completely exchanged with a brightness of the second pixel (255) as a result of the re-arrangement, and further, a brightness of the fourth pixel (255) is completely exchanged with a brightness of the third pixel (0) as a result of the re-arrangement. Thus, image quality is significantly degraded relative to the original image.

In contrast, since the re-arrangement in the first embodiment is carried out only to the lower three bits, for instance, it is possible to prevent degradation of image quality relative to the original image.

As explained above, the plasma display apparatus in accordance with the first embodiment is designed to include the re-arrangement circuit 13 which re-arranges or changes arrangement of image signals within a plurality of pixels such that a part of pixels (for instance, 2×2 pixels) among pixels constituting image is shifted without changing the arrangement of pixels in the part of pixels, and display images, based on the image signals to which the re-arrangement or signal-arrangement was carried out by the re-arrangement circuit 13. Hence, it is possible to reduce moving-picture pseudo-frame, and in addition, moving-picture pseudo-frame is reduced independently of a direction in which moving-picture moves.

Furthermore, since the re-arrangement is carried out only to a part of bit signals constituting an image signal, it would be possible to prevent degradation in image quality relative to original images.

In addition, since the re-arrangement is carried out only to lower n-bit (for instance, lower 3-bit) constituting an image signal, it would be possible to prevent degradation in image quality relative to original images.

Furthermore, since the re-arrangement is carried out to a plurality of bit signals (for instance, three bits) constituting an image signal, it would be possible to certainly reduce moving-picture pseudo-frame.

Furthermore, the estimate-performing circuit 11 estimates whether moving-picture pseudo-frame is generated, when images are displayed without carrying out the re-arrangement to image signals, and if the estimate-performing circuit 11 estimates generation of moving-picture pseudo-frame, the re-arrangement circuit 13 carries out the re-arrangement to image signals associated with pixels including pixels at which moving-picture pseudo-frame is estimated to generate. Hence, it is possible to prevent degradation in image quality as a result of carrying out the re-arrangement regardless of no generation of moving-picture pseudo-frame.

In the first embodiment, the re-arrangement is carried out to 2×2 pixels. It should be noted that 2×2 pixels are just an example, and the re-arrangement may be carried out to M×M pixels wherein M is equal to or greater than three (3). That is, “M” in FIG. 15 may be set equal to or greater than three (3).

In the re-arrangement in the first embodiment, pixels are rotated in a counterclockwise (or clockwise) direction by 90 degrees. It should be noted that pixels may be rotated by 90 degrees a plurality of times. That is, the exponent “p” in FIG. 15 may be set equal to or greater than two (2).

As an alternative, mirror-image reversal may be applied as the re-arrangement to pixels. That is, the exponent “p” in FIG. 15 is set equal to zero (0), and the exponent “q” of the reversal matrix H is set equal to one (1).

As an alternative, the re-arrangement may be comprised of a combination of rotation and mirror-image reversal. For instance, the re-arrangement may be comprised of rotation by 90 degrees once to three times and mirror-image reversal, in which case, the exponent “p” is set equal to 1, 2 or 3 and the exponent “q” is set equal to 1 in FIG. 15.

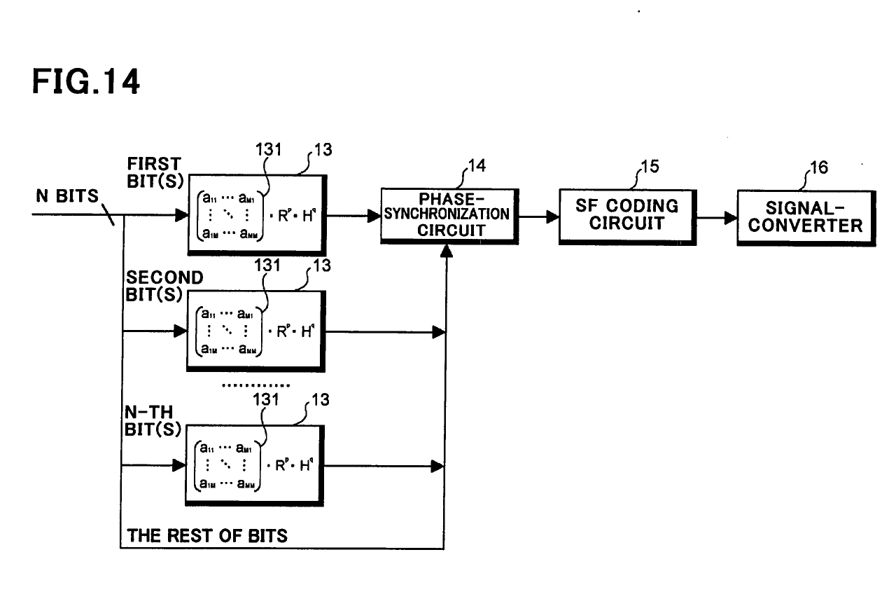

The circuit 10 may be designed to include a plurality of the re-arrangement circuits 13, as illustrated in FIG. 14, in which case, the re-arrangement is applied to each of a plurality of bit signals in each of the re-arrangement circuits 13.

When the circuit 10 includes a plurality of the re-arrangement circuits 13, the re-arrangement may be carried out to a smaller range of pixels in upper bits. The upper bit signals are much influenced by degradation in image quality caused by the re-arrangement, and the lower bit signals are less influenced by the degradation. By carrying out the re-arrangement to a smaller range of pixels in upper bits, the re-arrangement can be carried out to the upper bit signals so as to ensure the upper bit signals to be less influenced, and the re-arrangement can be carried out to the lower bit signals in a broad range of pixels so as to ensure reduction in moving-picture pseudo-frame.

In the first embodiment, the re-arrangement is carried out to a plurality of bit signals (for instance, bit signals corresponding to lower three bits). As an alternative, the re-arrangement may be applied to any one of bits in a bit signal.

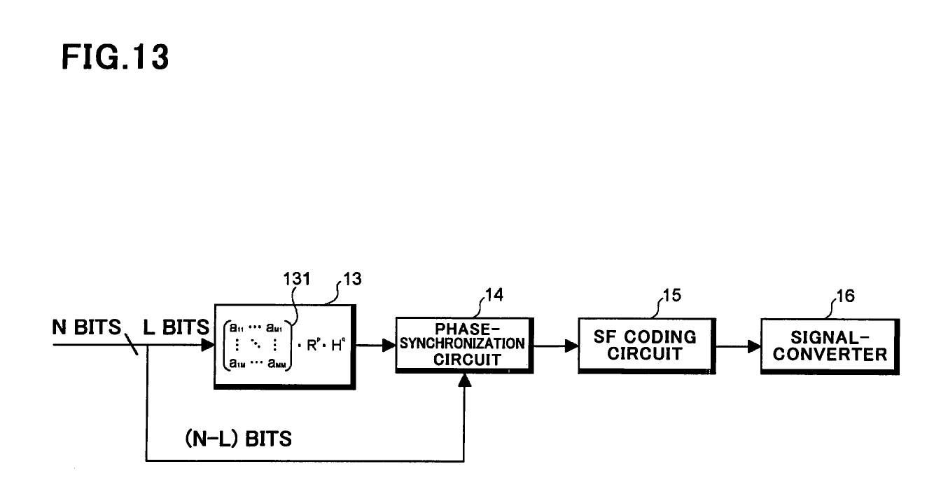

The re-arrangement may be carried out not only to a lower bit or lower bits, but also to an upper bit or upper bits. In other words, the re-arrangement may be carried out to any part of bit signals, as illustrated in FIG. 13, regardless of whether it is an upper or lower bit.

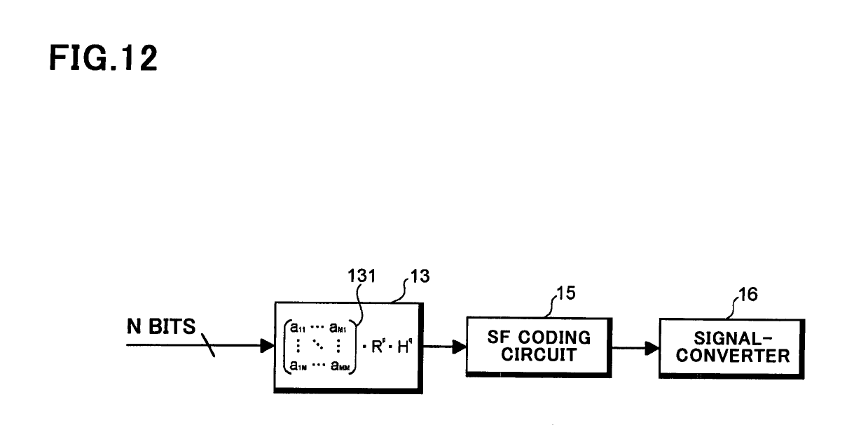

Furthermore, the re-arrangement may be 90-degrees rotation, mirror-image reversal, repetition of them alone or in combination, in which case, the re-arrangement may be applied to all of bit signals, as illustrated in FIG. 12, as well as to a part of bit signals.

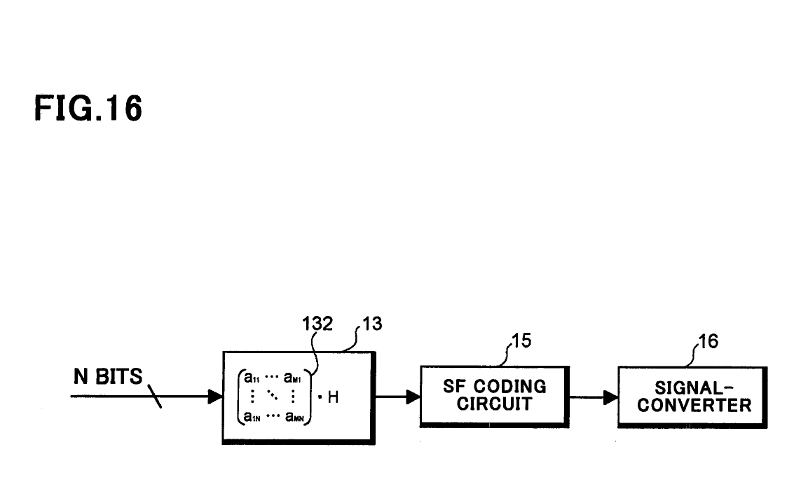

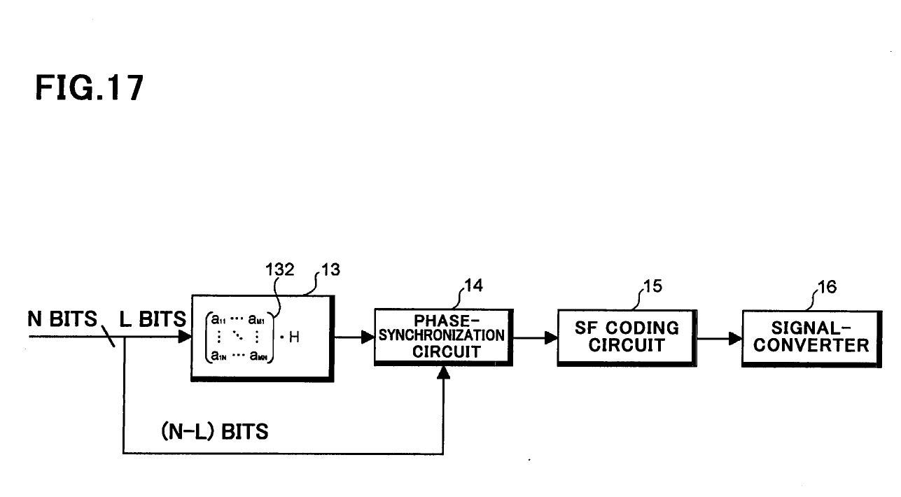

In the first embodiment, the re-arrangement is carried out to M×M pixels wherein M is an integer equal to or greater than two (2). Pixels to which the re-arrangement is applied are not to be limited to M×M pixels. As illustrated in FIGS. 16 to 19, the re-arrangement such as mirror-image reversal may be applied to M×N pixels wherein each of M and N is an integer equal to or greater than two (2), and M is not equal to N. In FIGS. 16 to 19, a matrix 132 is a M×N matrix (M≠N).

The re-arrangement may be applied to M×N pixels in the same way as the re-arrangement applied to M×M pixels.

For instance, as illustrated in FIG. 16, mirror-image reversal may be applied to all of bit signals.

As an alternative, mirror-image reversal may be applied only to a part of bit signals (L bits), and not applied to the rest of bit signals ((N−L) bits).

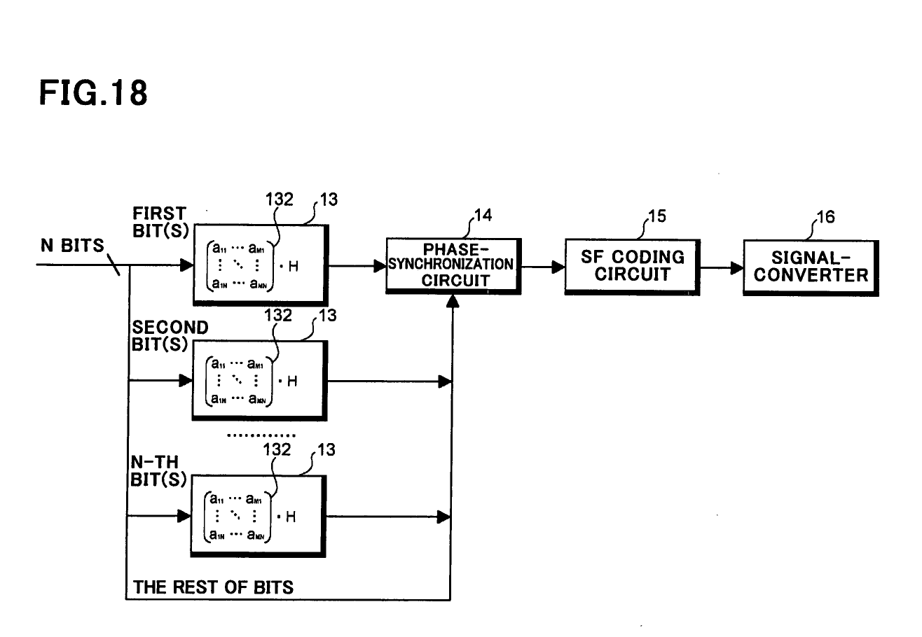

As an alternative, as illustrated in FIG. 18, when mirror-image reversal is applied to a plurality of bit signals, the circuit 10 may include a plurality of the re-arrangement circuits 13 each of which carries out the re-arrangement to each of bit signals.

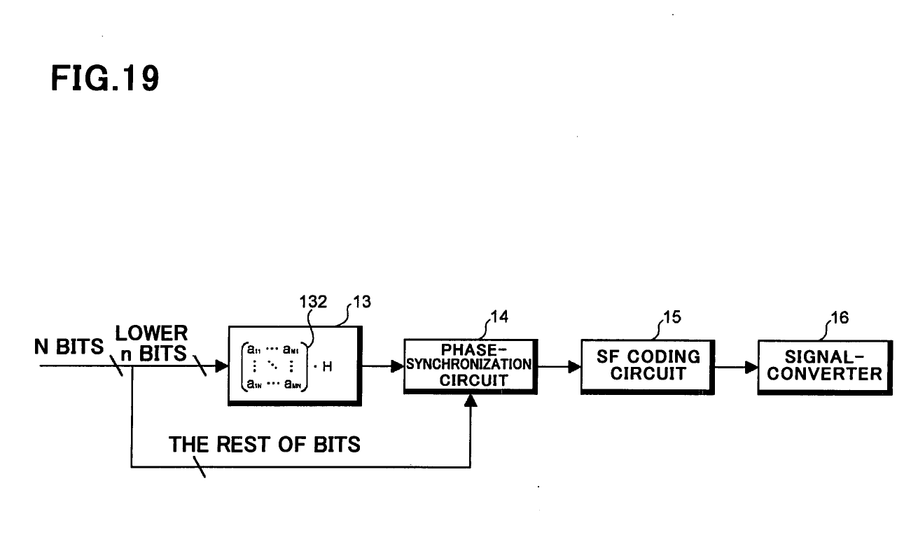

As an alternative, mirror-image reversal may be carried out only to lower n bits in a bit signal, as illustrated in FIG. 19.

In the first embodiment, the re-arrangement is applied to a group of pixels such as M×M pixels or M×N pixels. As an alternative, the re-arrangement may be applied to a group of pixels arranged in any configuration.

It is not always necessary for the re-arrangement to be comprised of 90-degrees rotation and/or mirror-image reversal. For instance, the re-arrangement may be comprised of reversal in point-symmetry. In the re-arrangement, pixels may be rotated in a clockwise direction as well as in a counterclockwise direction.

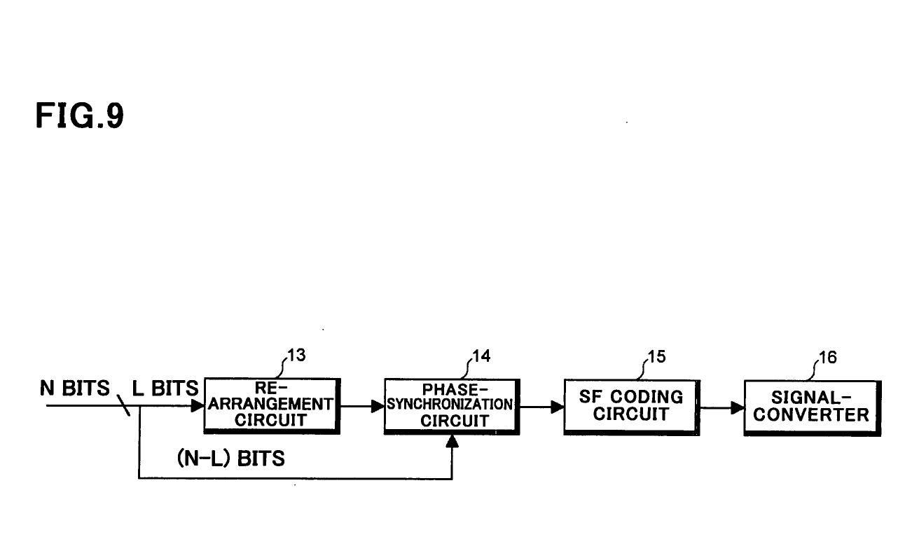

In the above-mentioned first embodiment, the re-arrangement is applied to a group of pixels. As an alternative, a part of bit signals among bit signals constituting an image signal may be re-arranged among a plurality of pixels, as illustrated in FIGS. 9 to 11. This ensures reduction in moving-picture pseudo-frame and prevention of degradation in image quality relative to images derived from the original image signals.

For instance, some bit signals among bit signals constituting an image signal may be re-arranged in the following ways.

The re-arrangement may be applied only to any part of bit signals (L bits), and not applied to the rest of bit signals ((N−L) bits), as illustrated in FIG. 9.

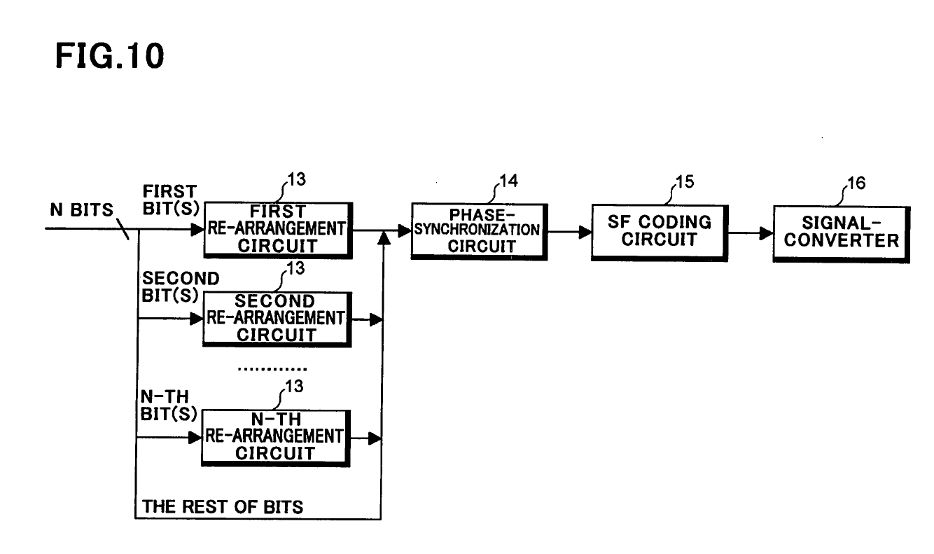

As an alternative, as illustrated in FIG. 10, when the re-arrangement is applied to a plurality of bit signals, the circuit 10 may include a plurality of the re-arrangement circuits 13 each of which carries out the re-arrangement to each of bit signals.

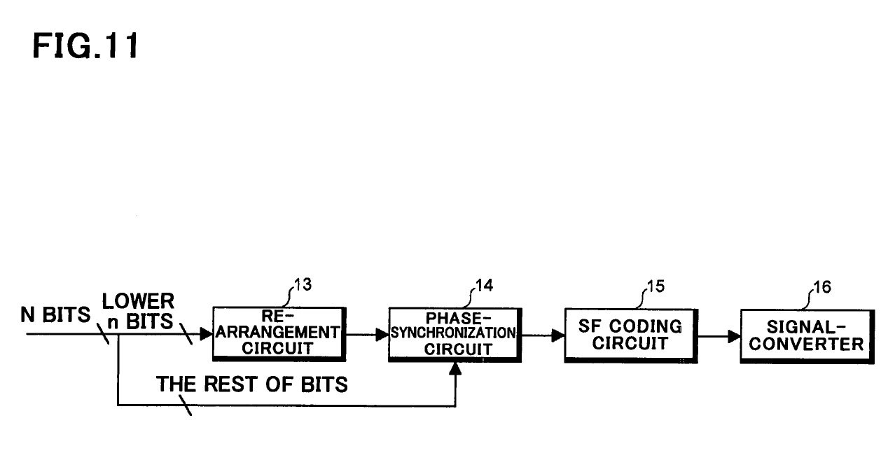

As an alternative, the re-arrangement may be carried out only to lower n bits in a bit signal, as illustrated in FIG. 11.

In the above-mentioned cases, the re-arrangement is carried out to pixels belonging to a common field. As an alternative, the re-arrangement may be carried out to pixels not only in a common field, but also in a plurality of fields close to one another in time sequence.

In the above-mentioned cases, a plasma display apparatus is selected as an apparatus for displaying images at multiple gray scales. An apparatus to which the present invention is applied is not to be limited to a plasma display apparatus. The present invention may be applied to any apparatus, if it displays images at multiple gray scales.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-167953 filed on Jun. 12, 2003 including specification, claims, drawings and summary is incorporated herein by reference in its entirety.

What is claimed is:

1. An apparatus for displaying images at multiple gray scales,
said apparatus, when each of pixels in image is displayed based on image signals having a certain number of bits, defining a field with a plurality of sub-fields each having a weighted brightness, to establish a desired gray scale,
said apparatus including a signal-arrangement changer which changes arrangement of a part of bit signals among bit signals constituting an image signal, in a plurality of pixels,
said apparatus displaying images, based on image signals, after said arrangement has been changed by said signal-arrangement changer.

2. The apparatus as set forth in claim 1, wherein said signal-arrangement changer carries out said arrangement-changing to a plurality of bit signals among bit signals constituting an image signal.

3. The apparatus as set forth in claim 2, wherein the apparatus includes a plurality of signal-arrangement changers each for each of bit signals to which said arrangement-changing is carried out.

4. The apparatus as set forth in claim 2, wherein said signal-arrangement changer carries out said arrangement-changing to a smaller range of pixels in upper bits.

5. The apparatus as set forth in claim 1, wherein said signal-arrangement changer carries out said arrangement-changing only to lower N-bit signals among bit signals constituting an image signal, wherein N is a positive integer.

6. The apparatus as set forth in claim 1, further comprising a device which estimates whether moving-picture pseudo-frame is generated when images are displayed without carrying out said signal-arrangement changing to image signals,
wherein said signal-arrangement changer, when said device estimates that moving-picture pseudo-frame is generated, carries out said signal-arrangement changing to images signals associated with pixels including pixels in which said moving-picture pseudo-frame is estimated to be generated.

7. The apparatus as set forth in claim 1, wherein said apparatus is comprised of a plasma display apparatus.

8. An apparatus for displaying images at multiple gray scales,
said apparatus, when each of pixels in image is displayed based on image signals having a certain number of bits, defining a field with a plurality of sub-fields each having a weighted brightness, to establish a desired gray scale,
said apparatus including a signal-arrangement changer which changes arrangement of image signals within a plurality of pixels such that a part of pixels among pixels constituting image is shifted without changing arrangement of pixels in said part,
said apparatus displaying images, based on image signals, after said arrangement has been changed by said signal-arrangement changer.

9. The apparatus as set forth in claim 8, wherein said signal-arrangement changer carries out 90-degrees rotation, mirror-image reversal, repetition of them alone or in combination to M×M pixels as said part of pixels, wherein M indicates a positive integer equal to or greater than two.

10. The apparatus as set forth in claim 8, wherein said signal-arrangement changer carries out mirror-image reversal to M×N pixels as said part of pixels, wherein each of M and N indicates a positive integer equal to or greater than two and M is not equal to N.

11. The apparatus as set forth in claim 8, wherein said signal-arrangement changer carries out said arrangement-changing only to a part of bit signals among bit signals constituting an image signal.

12. The apparatus as set forth in claim 8, wherein said signal-arrangement changer carries out said arrangement-changing to a plurality of bit signals among bit signals constituting an image signal.

13. The apparatus as set forth in claim 12, wherein the apparatus includes a plurality of signal-arrangement changers each for each of bit signals to which said arrangement-changing is carried out.

14. The apparatus as set forth in claim 12, wherein said signal-arrangement changer carries out said arrangement-changing to a smaller range of pixels in upper bits.

15. The apparatus as set forth in claim 8, wherein said signal-arrangement changer carries out said arrangement-changing only to lower N-bit signals among bit signals constituting an image signal, wherein N is a positive integer.

16. The apparatus as set forth in claim 8, further comprising a device which estimates whether moving-picture pseudo-frame is generated when images are displayed without carrying out said signal-arrangement changing to image signals,
wherein said signal-arrangement changer, when said device estimates that moving-picture pseudo-frame is generated, carries out said signal-arrangement changing to images signals associated with pixels including pixels in which said moving-picture pseudo-frame is estimated to be generated.

17. The apparatus as set forth in claim 8, wherein said apparatus is comprised of a plasma display apparatus.

18. A method of reducing moving-picture pseudo-frame in an apparatus for displaying images at multiple gray scales, said apparatus, when each of pixels in image is displayed based on image signals having a certain number of bits, defining a field with a plurality of sub-fields each having a weighted brightness, to establish a desired gray scale,
said method including:
changing arrangement of a part of bit signals among bit signals constituting an image signal, in a plurality of pixels; and
displaying images, based on image signals, after said arrangement has been changed by said signal-arrangement changer.

19. The method as set forth in claim 18, wherein said arrangement-changing is carried out to a plurality of bit signals among bit signals constituting an image signal.

20. The method as set forth in claim 19, wherein said arrangement-changing is carried out to a smaller range of pixels in upper bits.

21. The method as set forth in claim 18, wherein said arrangement-changing is carried out only to lower N-bit signals among bit signals constituting an image signal, wherein N is a positive integer.

22. The method as set forth in claim 18, further comprising estimating whether moving-picture pseudo-frame is generated when images are displayed without carrying out said signal-arrangement changing to image signals,
wherein when moving-picture pseudo-frame is estimated to be generated, said signal-arrangement changing is carried out to images signals associated with pixels including pixels in which said moving-picture pseudo-frame is estimated to be generated.

23. A method of reducing moving-picture pseudo-frame in an apparatus for displaying images at multiple gray scales, said apparatus, when each of pixels in image is displayed based on image signals having a certain number of bits, defining a field with a plurality of sub-fields each having a weighted brightness, to establish a desired gray scale,
said method including:
changing arrangement of image signals within a plurality of pixels such that a part of pixels among pixels constituting image is shifted without changing arrangement of pixels in said part; and
displaying images, based on image signals, after said arrangement has been changed by said signal-arrangement changer.

24. The method as set forth in claim 23, wherein 90-degrees rotation, mirror-image reversal, repetition of them alone or in combination is carried out as signal-arrangement changing to M×M pixels as said part of pixels, wherein M indicates a positive integer equal to or greater than two.

25. The method as set forth in claim 23, wherein mirror-image reversal is carried out as signal-arrangement changing to M×N pixels as said part of pixels, wherein each of M and N indicates a positive integer equal to or greater than two and M is not equal to N.

26. The method as set forth in claim 23, wherein said arrangement-changing is carried out only to a part of bit signals among bit signals constituting an image signal.

27. The method as set forth in claim 23, wherein said arrangement-changing is carried out to a plurality of bit signals among bit signals constituting an image signal.

28. The method as set forth in claim 27, wherein said arrangement-changing is carried out to a smaller range of pixels in upper bits.

29. The method as set forth in claim 23, wherein said arrangement-changing is carried out only to lower N-bit signals among bit signals constituting an image signal, wherein N is a positive integer.

30. The method as set forth in claim 23, further comprising estimating whether moving-picture pseudo-frame is generated when images are displayed without carrying out said signal-arrangement changing to image signals,
wherein when moving-picture pseudo-frame is estimated to be generated, said signal-arrangement changing is carried out to images signals associated with pixels including pixels in which said moving-picture pseudo-frame is estimated to be generated.
